(19) United States
(12) Patent Application Publication
(10) Pub. No.: US 2009/0311042 A1
(43) Pub. Date: Dec. 17, 2009

(54) Fastening Device, Particularly Adapted to Be Fastened on Members Having a Grooved Profile

(76) Inventors: Corrado Fontana, Marostica (IT); Roberto Fontanive, Santa Giustian (IT)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(21) Appl. No.: 12/085,888

(22) PCT Filed: Nov. 2, 2006
(86) PCT No.: PCT/EP2006/010531

§ 371 Date: Jun. 2, 2008

(30) Foreign Application Priority Data
Dec. 5, 2005 (IT) PD2005A000356

(51) Int. Cl. F16B 2/16; F16B 7/04

(52) U.S. Cl. 403/350; 403/7

(57) ABSTRACT

A fastening device adapted in particular to be fastened on members having a grooved profile. The device has a main body, a control pin housed in engagement in this main body in an axial direction and moving with respect to this main body in order selectively to control the fastening or disengagement of this device, and a pressure member housed in the main body and moving with respect to the latter in a transverse direction. The pressure member is associated with the control pin such that, following the movement of the control pin with respect to the main body, the pressure member is moved in the transverse direction from and towards an operating position in which it projects from the main body.

### RELATED APPLICATION

This application is a U.S. national phase application of International Application No. PCT/EP2006/010531 filed on Nov. 2, 2006.

### TECHNICAL FIELD

The present invention relates generally to fastening devices and, more particularly, to a fastening device adapted to be fastened on members having a grooved profile.

### TECHNOLOGICAL BACKGROUND

A particular, but not exclusive, application of the invention is in the technical sector of the production and assembly of display structures for shops or trade-fair stands.

These structures typically comprise a plurality of components which can be assembled in different ways so that their use is as versatile as possible and meets the functional, spatial and design requirements of each display area, while at the same time using as few components as possible.

Among such structures, the use of members, in particular uprights, having a grooved profile is widespread; the outer surfaces of these members are provided with one or a plurality of grooves, typically longitudinal, in which appropriate fastening devices are locked in a preferred position of the groove. Further members of the display structure, for instance crossbars, brackets or shelves are then coupled to the fastening devices thus providing, once they have all been coupled, the display structure.

Devices for fastening to the above-mentioned members having a grooved profile typically comprise a shoe engaged in a sliding manner in the groove via a pair of opposing flanges. The device is locked in the preferred position of the groove by the action of one or a plurality of through screws housed in the shoe and screwed tightly against the base wall of the groove so that the flanges of the shoe are urged against the lateral walls of the grooved profile which has an appropriate swallowtail shape.

These devices, while ensuring robust fastening to the member having a grooved profile, nevertheless have some drawbacks. The main drawback lies in the fact that the screws tend to cut into the base surface of the groove, spoiling its finish. In this way, when the fastening device is moved into another position along the groove, the damage becomes visible and compromises the overall aesthetic appearance of the structure.

Devices are also known in the more general field of mechanisms for coupling two members which, once inserted in an appropriate seat provided in one of the members to be coupled, require a moving part of the device to be radially displaced in order to prevent the device from slipping out of the seat. This operation may take place, for instance, by rotating an eccentric member housed in a lateral recess of the seat, or, as in the case of a screw anchor, by opening out the longitudinal halves of a cylindrical sleeve housing a screw following its insertion into the sleeve.

However, these devices merely prevent the slipping of the fastening device and, therefore, although efficient in the case in which the coupling seats are formed by holes, are entirely inadequate when the seat is of the type described above in relation to members having a grooved profile.

### SUMMARY OF THE INVENTION

The problem underlying the present invention is that of providing a fastening device structurally and functionally designed to remedy the drawbacks described above with respect to conventional devices. To overcome these and other drawbacks, and in view of its purposes, the present invention provides a fastening device adapted to be fastened on a member having a grooved profile defining a groove. The fastening device has a main body, a control pin, and a pressure member. The main body has a sliding surface disposed along a transverse axis. The control pin is housed in the main body and disposed along a second axis defining an axial direction, the transverse axis being inclined with respect to the second axis and the control pin moving with respect to the main body in order selectively to control the fastening or disengagement of the device. The pressure member is housed in the main body, adjacent to the main body at the sliding surface, and moves with respect to the main body in a transverse direction along the transverse axis. The pressure member is associated with the control pin such that, following the movement of the control pin with respect to the main body, the pressure member is moved in the transverse direction from and towards an operating position in which it projects from the main body. The control pin is directly connected to the pressure member in order to move the pressure member in the transverse direction while bearing on the sliding surface and the pressure member is held in connection with the main body through the connection with the control pin.

It is to be understood that both the foregoing general description and the following detailed description are exemplary, but are not restrictive, of the invention.

### BRIEF DESCRIPTION OF THE DRAWINGS

The characteristic features and advantages of the invention are set out in further detail in the following detailed description of some preferred embodiments thereof, shown by way of non-limiting example in the accompanying drawings in which:

FIG. 1 is a front perspective view of a fastening device according to a first embodiment of the present invention, in a first non-operational position;

FIG. 2 is a perspective view from behind the device of FIG. 1;

FIGS. 3a and 3b are front views of the device of FIG. 1, in the first non-operational position and in a second operating position respectively;

FIG. 4 is a lateral view from the left, partly in section, of the device of FIG. 1;

FIG. 5 is a cross-sectional view of the fastening device of FIG. 1 along the line V-V of FIG. 3a;

FIG. 6 is a front perspective view of a fastening device according to a second embodiment of the present invention, in a first non-operational position;

FIG. 7 is a perspective view from behind the device of FIG. 6;

FIG. 8 is a front view of the device of FIG. 6;

FIG. 9 is a lateral view from the left, in section along the line IX-IX of FIG. 8, of the device of FIG. 6; and

FIG. 10 is a cross-sectional view of the fastening device of FIG. 6 along the line X-X of FIG. 8, in a second operating position.

### PREFERRED EMBODIMENTS OF THE INVENTION

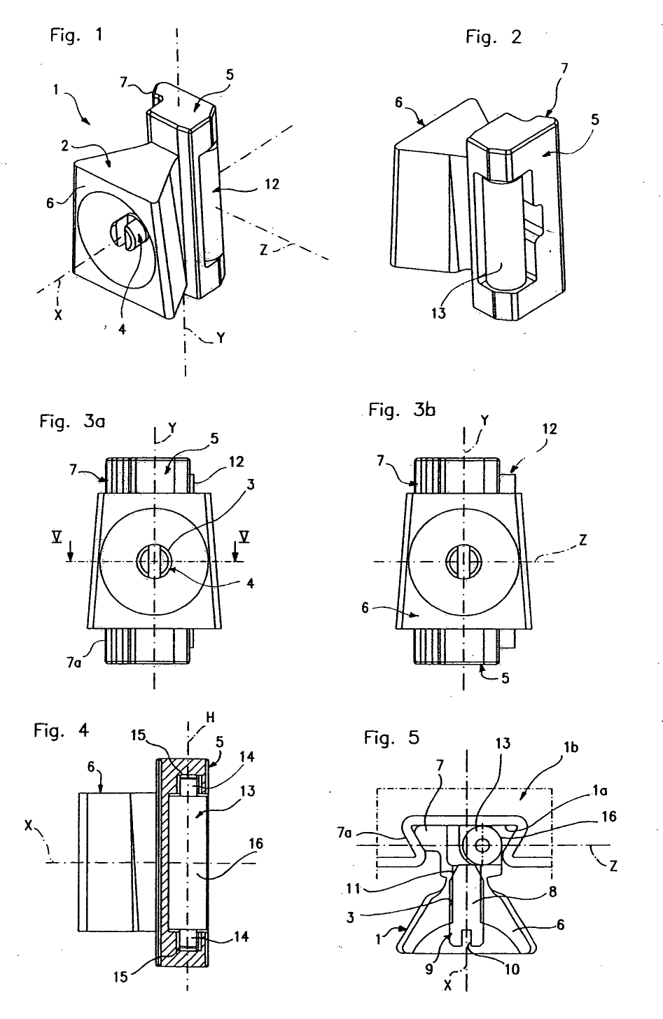

Referring initially to FIGS. 1 to 5, which show a first preferred embodiment of the invention, a fastening device is shown overall by the reference numeral 1 and can be locked in engagement in a groove 1a having a swallowtail section.

The groove 1a forms part of a member having a grooved profile 1b of a display structure of a known type which is partially shown in dashed lines in FIG. 5.

The device 1 comprises a main body 2 provided with a threaded hole 3, disposed along an axis X, acting as a seat housing a control pin 4.

The main body 2 in turn comprises a shoe portion 5 which may be inserted in a sliding manner in the groove 1a, and a projecting front portion 6 in which the threaded hole 3 is provided and which extends from the shoe portion 5 along the axis X.

The shoe portion 5 extends along an axis Y substantially perpendicular to the axis X and parallel to the direction in which the groove 1a extends so as to facilitate the sliding of the device 1 within that groove. The shoe portion 5 comprises a lateral flange 7 on which an abutment surface 7a is defined and is adapted to abut against the inner wall of the groove 1a.

The projecting front portion 6 advantageously has a swallowtail shape so as to form an efficient connection with further components of the display structure according to known methods.

The control pin 4 comprises a threaded cylindrical rod 8 disposed along the axis X whose opposing axial ends are in the form of a point 11 with a conical profile and a head 9, accessible from outside the device 1, in which a control key 10 is provided.

According to a main aspect of the present invention, the device 1 further comprises a pressure member 12 housed in a sliding manner in the main body 2 and able to move with respect thereto in a transverse direction along the axis Z, substantially perpendicular with respect to both the axis X and the axis Y along which the device 1 slides within the groove 1a.

The pressure member 12 may move in the transverse direction along the axis Z between a first non-operational position in which the pressure member 12 is substantially housed in the shoe portion 5 (shown in FIGS. 1, 2, 3a and 5) and a second operating position in which the pressure member 12 projects from the shoe portion 5 on the side opposite the lateral flange 7 (shown in FIG. 3b).

The pressure member 12 comprises a cylindrical pin 13 disposed along the axis H substantially parallel to the axis Y from whose opposing axial ends two lugs 14 extend and are housed in respective seats 15 provided in the shoe portion 5 and extending in the transverse direction along the axis Z.

An abutment surface 16 is also defined on the cylindrical pin 13 and is substantially parallel to the abutment surface 7a of the lateral flange 7 and adapted to abut against the wall of the groove 1a on the side opposite the lateral flange 7 when the pressure member 12 is moved into the operating position.

The positioning of the pressure member 12 and the control pin 4 within the main body 2 is such that they mesh with one another at respective contact surfaces when the control pin 4 is moved in the axial direction along the axis X. In particular, when the control pin 4 is moved in the axial direction along the axis X within the main body 2, the point 11 having a conical profile of the control pin 4 advantageously comes into contact with a jacket portion of the cylindrical pin 13 of the pressure member 12 so that the latter is moved in the transverse direction along the axis Z towards the operating position.

The dimension of the cylindrical pin 13 in the direction along the axis Y is advantageously 50% greater than the corresponding dimension of the lateral flange 7. In this way, the pressure exerted by the pressure member 12 on the inner wall of the member having a grooved profile 1b is comparable to that exerted by the lateral flange 7, avoiding localized pressures which are too high and likely to cause cuts or damage to the surface finish of the inner wall of the groove 1a.

The fastening device 1 operates as follows. The shoe portion 5 is inserted in a sliding manner in the groove 1a, with the pressure member 12 housed substantially therein, in the non-operational position.

Once the device 1 has been positioned at the preferred height, the control pin 4 is screwed into the main body 2 using the control key 10. The movement of the control pin 4 in the axial direction along the axis X causes the pressure member 12 to move towards the operating position so as to project from the shoe portion 5 until its abutment surface 16 abuts the inner wall of the groove 1a. Using an appropriate screwing force, the device 1 is locked in position as a result of the abutment of the opposing abutment surfaces 7a and 16.

The locking obtained is efficient and enables the device to withstand substantial forces even in the direction along the axis Y and, at the same time, as a result of the fact that no localized pressure is exerted on the base of the groove 1a and the fact that the abutment surfaces 7a and 16 are relatively broad, the groove 1a is not cut or damaged.

FIGS. 5 to 10 shows a fastening device 100 representing a second preferred embodiment of the invention, in which details similar to the device 1 of the previous embodiment bear the same reference numerals.

The device 100 differs from the device 1 in that the control pin 4 is housed in screwing engagement in a threaded hole 101 provided in the pressure member 12 rather than in the main body 2.

In this case, therefore, the rotation of the control pin 4 about its axis X does not cause the pin 4 to move along the axis X, but causes the pressure member 12 to move along the rod 8.

It will be appreciated that, in this case, the pressure member 12 is advantageously held in connection with the main body 2 directly by the screw connection with the control pin 4 so that the seats 15 and the lugs 14 are no longer needed.

The pressure member 12 is moved in the transverse direction along the axis Z by sliding it along a sliding surface 102 provided in the shoe portion 5 to which the pressure member 12 is adjacent. The sliding surface 102 defines the transverse direction along the axis Z which, in this case, is inclined with respect to the axis X by an angle of less than 90°, preferably approximately 45°.

Moreover, the hole 3 provided in the projecting front portion 6 is not threaded and has a section which is advantageously elliptical, elongated laterally from the side towards which the pressure member 12 projects when moved into the operating position.

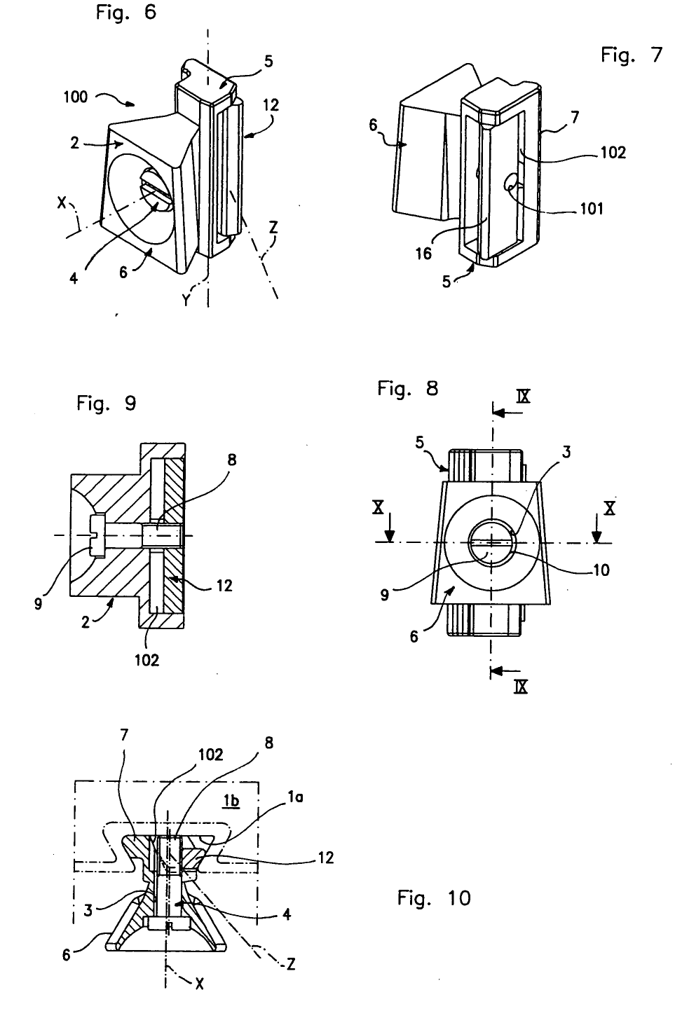

In order to lock the device 100 in engagement within the member having a grooved profile 1b, once the device 100 has been positioned at the desired height, the control pin 4 is screwed as a result of which the pressure member 12 is moved along the rod 8 towards the head 9 of the pin 4. Moreover, as a result of the provision of the sliding surface 102, the pressure member 12 is moved, relative to the main body 2, in the transverse direction along the axis Z from the non-operational position shown in FIGS. 6 to 9 to the operating position shown in FIG. 10.

As a result of this operation, the control pin 4 is also moved, relative to the main body 2, laterally within the hole 3.

As in the preceding embodiment, robust and efficient locking of the device 100 in the groove 1a, without cuts or damage to its surface finish, is obtained in this case as well.

The present invention thus resolves the problem set out above with reference to the conventional devices. Although illustrated and described above with reference to certain specific embodiments, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

1.-14. (canceled)

15. A fastening device adapted to be fastened on a member having a grooved profile defining a groove, the fastening device comprising:
a main body having a sliding surface disposed along a transverse axis;
a control pin housed in the main body and disposed along a second axis defining an axial direction, the transverse axis being inclined with respect to the second axis and the control pin moving with respect to the main body in order selectively to control the fastening or disengagement of the device; and
a pressure member housed in the main body, adjacent to the main body at the sliding surface, and moving with respect to the main body in a transverse direction along the transverse axis, the pressure member being associated with the control pin such that, following the movement of the control pin with respect to the main body, the pressure member is moved in the transverse direction from and towards an operating position in which it projects from the main body, the control pin being directly connected to the pressure member in order to move the pressure member in the transverse direction while bearing on the sliding surface and the pressure member being held in connection with the main body through the connection with the control pin.

16. The fastening device according to claim 15, wherein the main body includes a shoe portion having a lateral flange and being shaped to slide within the groove of the member having a grooved profile, the pressure member being housed in a sliding manner in the shoe portion so as to project from the shoe portion on the opposite side with respect to the lateral flange when moved by the control pin.

17. The fastening device according to claim 16, wherein the pressure member and the lateral flange have corresponding abutment surfaces adapted to abut against opposing inner walls of the groove, these abutment surfaces extending in a direction substantially perpendicular to the transverse direction in which the pressure member is moved.

18. The fastening device according to claim 16, wherein the main body further includes a projecting front portion (a) extending from the shoe portion in the axial direction, and (b) defining a hole receiving the control pin.

19. The fastening device according to claim 18, wherein the hole defined in the projecting front portion is not threaded and has an elliptical section, elongated laterally from the side towards which the pressure member projects when moved into the operating position.

20. The fastening device according to claim 18, wherein the projecting front portion of the main body has a swallowtail shape.

21. The fastening device according to claim 15, wherein the control pin has, at its first end, a head with a control key accessible from outside the device in order to move the control pin with respect to the main body.

22. The fastening device according to claim 15, wherein the pressure member defines a threaded hole and the control pin has a threaded rod housed in screwing engagement in the threaded hole defined by the pressure member.

23. The fastening device according to claim 15, wherein the transverse axis is inclined with respect to the second axis by an angle of less than ninety degrees.

24. The fastening device according to claim 23, wherein the transverse axis is inclined with respect to the second axis by an angle of approximately forty-five degrees.

25. A fastening device adapted to be fastened on a member having a grooved profile defining a groove, the fastening device comprising:
a main body having a sliding surface disposed along a transverse axis, a shoe portion including a lateral flange and being shaped to slide within the groove of the member having a grooved profile, and a projecting front portion (a) extending from the shoe portion along a second axis defining an axial direction, and (b) defining a hole;
a control pin received in the hole defined in the projecting front portion of the main body and disposed along the second axis, the transverse axis being inclined with respect to the second axis and the control pin having a threaded rod and a head with a control key accessible from outside the device in order to move the control pin with respect to the main body in order selectively to control the fastening or disengagement of the device; and
a pressure member housed in a sliding manner in the shoe portion of the main body, adjacent to the main body at the sliding surface, so as to project from the shoe portion on the opposite side with respect to the lateral flange when moved by the control pin and moving with respect to the main body in a transverse direction along the transverse axis, the pressure member defining a threaded hole receiving the threaded rod of the control pin such that, following the movement of the control pin with respect to the main body, the pressure member is moved in the transverse direction from and towards an operating position in which it projects from the main body, the control pin being in screwing engagement with the pressure member in order to move the pressure member in the transverse direction while bearing on the sliding surface and the pressure member being held in connection with the main body through the connection with the control pin.

26. The fastening device according to claim 25, wherein the pressure member and the lateral flange have corresponding abutment surfaces adapted to abut against opposing inner walls of the groove, these abutment surfaces extending in a direction substantially perpendicular to the transverse direction in which the pressure member is moved.

27. The fastening device according to claim 25, wherein the hole defined in the projecting front portion is not threaded and has an elliptical section, elongated laterally from the side towards which the pressure member projects when moved into the operating position.

28. The fastening device according to claim 25, wherein the projecting front portion of the main body has a swallowtail shape.

29. The fastening device according to claim 25, wherein the transverse axis is inclined with respect to the second axis by an angle of less than ninety degrees.

30. A fastening system comprising:
a member having a grooved profile defining a groove; and
a fastening device including:
(a) a main body having a sliding surface disposed along a transverse axis,
(b) a control pin housed in the main body and disposed along a second axis defining an axial direction, the transverse axis being inclined with respect to the second axis and the control pin moving with respect to the main body in order selectively to control the fastening or disengagement of the device, and
(c) a pressure member housed in the main body, adjacent to the main body at the sliding surface, and moving with respect to the main body in a transverse direction along the transverse axis, the pressure member being associated with the control pin such that, following the movement of the control pin with respect to the main body, the pressure member is moved in the transverse direction from and towards an operating position in which it projects from the main body, the control pin being directly connected to the pressure member in order to move the pressure member in the transverse direction while bearing on the sliding surface and the pressure member being held in connection with the main body through the connection with the control pin.

31. The fastening system according to claim 30, wherein the main body includes a shoe portion having a lateral flange and being shaped to slide within the groove of the member having a grooved profile, the pressure member being housed in a sliding manner in the shoe portion so as to project from the shoe portion on the opposite side with respect to the lateral flange when moved by the control pin.

32. The fastening system according to claim 31, wherein the main body further includes a projecting front portion (a) extending from the shoe portion in the axial direction, and (b) defining a hole receiving the control pin.

33. The fastening system according to claim 30, wherein the control pin has, at its first end, a head with a control key accessible from outside the device in order to move the control pin with respect to the main body.

34. The fastening system according to claim 30, wherein the pressure member defines a threaded hole and the control pin has a threaded rod housed in screwing engagement in the threaded hole defined by the pressure member.
